(19) United States
(12) Patent Application Publication
(10) Pub. No.: US 2026/0302122 A1
(43) Pub. Date: Oct. 1, 2026

(54) INLINE FUSE HOLDER

(71) Applicant: Suzhou Littelfuse OVS Co., Ltd., Suzhou (CN)

(72) Inventors: Andrew Jozwiak, San Antonio, TX (US); Shangchun Pan, Suzhou (CN)

(73) Assignee: Suzhou Littelfuse OVS Co., Ltd., Suzhou (CN)

(21) Appl. No.: 19/630,669

(22) Filed: Mar. 27, 2026

(30) Foreign Application Priority Data
Mar. 31, 2025 (CN) 202510390424.1

(51) Int. Cl. H01H 85/25; H01H 85/00; H01H 85/02; H01H 85/20

(52) U.S. Cl. CPC H01H 85/25; H01H 85/0078; H01H 85/0241; H01H 85/2015; H01H 85/203; H01H 2085/209

(57) ABSTRACT

An inline fuse holder is provided that can hold two different types of fuses with a single holder while including features for preventing two fuses from being connected with the inline fuse holder simultaneously. The inline fuse holder can include a pin to prevent the two fuses from being connected with the inline fuse holder simultaneously; when electrically connected with one set of terminals, one of the two fuses can move the pin into a position where the pin prevents the other of the two fuses from electrically connecting with another set of terminals. The fuses themselves can also prevent the two fuses from being connected with the inline fuse holder simultaneously; when electrically connected with one set of terminals, one of the two fuses can physically interfere with the other of the two fuses electrically connecting with another set of terminals.

### CROSS-REFERENCE TO CORRESPONDING APPLICATIONS

This application claims the benefit of priority to, Chinese Patent Application No. 202510390424.1, filed Mar. 31, 2025, entitled "INLINE FUSE HOLDER," which application is incorporated herein by reference in its entirety.

### FIELD

The present disclosure generally relates to fuse holders. More particularly, the present disclosure relates to an inline fuse holder that is compatible with with different types of fuses.

### BACKGROUND

Inline fuse holders that hold a fuse between an input wire and an output wire are known in the art. However, known inline fuse holders can only hold a single type of fuse.

In view of the above, there is a continuing, ongoing need for improved inline fuse holders.

### BRIEF SUMMARY

In some embodiments, an inline fuse holder can include a first set of terminals for electrically connecting with a first fuse, a second set of terminals for electrically connecting with a second fuse, and a pin for preventing the first fuse from electrically connecting with the first set of terminals when the pin is in a first position and for preventing the second fuse from electrically connecting with the second set of terminals when the pin is in a second position.

In some embodiments, the first fuse can push the pin into the second position when the first fuse is electrically connected with the first set of terminals, and the second fuse can push the pin into the first position when the second fuse is electrically connected with the second set of terminals.

In some embodiments, the inline fuse holder can include a body housing the first set of terminals and the second set of terminals.

In some embodiments, the inline fuse holder can include a through hole disposed in the body between the first set of terminals and the second set of terminals, and the pin can be disposed in the through hole and slide within the through hole to move between the first position and the second position.

In some embodiments, the inline fuse holder can include a first shoulder disposed at a first end of the pin and extending outside of the through hole proximate the first set of terminals and a second shoulder disposed at a second end of the pin and extending outside of the through hole proximate the second set of terminals. The first shoulder and the second shoulder can prevent the pin from falling out of the through hole.

In some embodiments, diameters of the first shoulder and the second shoulder can be greater than a diameter of the through hole.

In some embodiments, a diameter of a shaft of the pin disposed between the first shoulder and the second shoulder can be greater than a diameter of the through hole.

In some embodiments, the first set of terminals can be compatible with a first type of fuses, the second set of terminals can be compatible with a second type of fuses, and the first type of fuses and the second type of fuses can be different types of fuses.

In some embodiments, an inline fuse holder can include a first set of terminals for electrically connecting with a first fuse and a second set of terminals for electrically connecting with a second fuse, wherein the first fuse can prevent the second fuse from electrically connecting with the second set of terminals when the first fuse is electrically connected with the first set of terminals, and the second fuse can prevent the first fuse from electrically connecting with the first set of terminals when the second fuse is electrically connected with the second set of terminals.

In some embodiments, the first fuse can physically interfere with the second fuse electrically connecting with the second set of terminals when the first fuse is electrically connected with the first set of terminals, and the second fuse can physically interfere with the first fuse electrically connecting with the first set of terminals when the second fuse is electrically connected with the second set of terminals.

In some embodiments, the inline fuse holder can include a body housing the first set of terminals and the second set of terminals.

In some embodiments, the first set of terminals can be compatible with a first type of fuse, the second set of terminals can be compatible with a second type of fuse, and the first type of fuse and the second type of fuse can be different types of fuses.

In some embodiments, the first set of terminals and the second set of terminals can be disposed side-by-side for receiving the first fuse and the second fuse, respectively, in one direction.

In some embodiments, the first set of terminals can open towards a first direction for receiving the first fuse, the second set of terminals can open towards a second direction for receiving the second fuse, and the first direction and the second direction can be opposite one another.

In some embodiments, a method can include providing a first set of terminals in an inline fuse holder, providing a second set of terminals in the inline fuse holder, preventing a second fuse from electrically connecting with the second set of terminals when a first fuse is electrically connected with the first set of terminals, and preventing the first fuse from electrically connecting with the first set of terminals when the second fuse is electrically connected with the second set of terminals.

In some embodiments, the method can include providing a pin between the first set of terminals and the second set of terminals, pushing, by the second fuse, the pin into a first position when the second fuse is electrically connected with the second set of terminals, the pin preventing the first fuse from electrically connecting with the first set of terminals when the pin is in the first position, and pushing, by the first fuse, the pin into a second position when the first fuse is electrically connected with the first set of terminals, the pin preventing the second fuse from electrically connecting with the second set of terminals when the pin is in the second position.

In some embodiments, the method can include disposing the pin in a through hole of a body housing the first set of terminals and the second set of terminals and sliding the pin within the through hole to move between the first position and the second position.

In some embodiments, the method can include preventing the pin from falling out of the through hole with shoulders on ends of the pin that extend outside of the through hole on opposing sides thereof, wherein the shoulders can have diameters larger than a diameter of the through hole.

In some embodiments, the method can include physically interfering, by the first fuse, with the second fuse electrically connecting with the second set of terminals when the first fuse is electrically connected with the first set of terminals and physically interfering, by the second fuse, with the first fuse electrically connecting with the first set of terminals when the second fuse is electrically connected with the second set of terminals.

In some embodiments, the method can include electrically connecting an input wire to an input terminal of the first set of terminals and and an input terminal of the second set of terminals and electrically connecting an output wire to an output terminal of the first set of terminals and an output terminal of the second set of terminals.

Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A is a perspective view illustrating an inline fuse holder in accordance with disclosed embodiments.

FIG. 1B is a side view illustrating an inline fuse holder with fuses therein in accordance with disclosed embodiments.

FIG. 2 is a side view illustrating an input adapter or an output adapter of an inline fuse holder in accordance with disclosed embodiments.

FIG. 3 is a side view illustrating an interior of an inline fuse holder in accordance with disclosed embodiments.

FIG. 4 is a side view illustrating an interior of an inline fuse holder in accordance with disclosed embodiments.

FIG. 5 is a perspective view illustrating a pin in accordance with disclosed embodiments.

FIG. 6A is a top view illustrating a body of an inline fuse holder with a through hole in accordance with disclosed embodiments.

FIG. 6B is a perspective view illustrating a body of an inline fuse holder with a pin disposed in a through hole in accordance with disclosed embodiments.

FIG. 6C is an enlarged side view illustrating a pin disposed in a body of an inline fuse holder in accordance with disclosed embodiments.

FIG. 7A is a perspective view illustrating an inline fuse holder with one fuse therein in accordance with disclosed embodiments.

FIG. 7B is a cutaway side view illustrating one fuse installed in an inline fuse holder relative to a pin in accordance with disclosed embodiments.

FIG. 7C is a perspective view illustrating a pin in a body of an inline fuse holder in accordance with disclosed embodiments.

FIG. 7D is a perspective view illustrating a pin preventing one fuse from installation in an inline fuse holder in accordance with disclosed embodiments.

FIG. 7E is an enlarged side view illustrating a pin preventing one fuse from installation in an inline fuse holder in accordance with disclosed embodiments.

FIG. 7F is a cutaway side view illustrating a pin preventing one fuse from installation in an inline fuse holder in accordance with disclosed embodiments.

FIG. 8 is a perspective view illustrating an inline fuse holder with fuses therein in accordance with disclosed embodiments.

FIG. 9 is a perspective view illustrating an input adapter or an output adapter of an inline fuse holder in accordance with disclosed embodiments.

FIG. 10 is a perspective view illustrating an interior of an inline fuse holder in accordance with disclosed embodiments.

FIG. 11A is a perspective view illustrating an inline fuse holder with one fuse therein in accordance with disclosed embodiments.

FIG. 11B is a top view illustrating an inline fuse holder with one fuse therein in accordance with disclosed embodiments.

FIG. 11C is a perspective view illustrating one fuse preventing another fuse from installation in an inline fuse holder in accordance with disclosed embodiments.

FIG. 12 is a flow chart illustrating a method in accordance with disclosed embodiments.

### DETAILED DESCRIPTION

Exemplary embodiments of an inline fuse holder in accordance with the present disclosure will now be described more fully hereinafter with reference made to the accompanying drawings. The inline fuse holder may, however, be embodied in many different forms and should not be construed as being limited to the embodiments set forth herein. Rather, these embodiments are provided so that this disclosure will convey certain exemplary aspects of the inline fuse holder to those skilled in the art.

In accordance with disclosed embodiments, an inline fuse holder can hold two different types of fuses with a single holder. Accordingly, a first of the two different types of fuses can be connected with the inline fuse holder or a second of the two different types of fuses can be connected with the inline fuse holder, depending on an application in which the inline fuse holder is being used and which of the two different types of fuses is available to a user. In this manner, the inline fuse holder as disclosed herein can provide flexibility and multiple options for maintaining functional operation the inline fuse holder.

For example, Fuse A, a first of the two different types of fuses, can be connected with the inline fuse holder. During operation, Fuse A can experience an overcurrent condition and open. However, if a replacement fuse that is also a first of the two different types of fuses is not readily available, then Fuse B, a second of the two different types of fuses, can be connected with the same inline fuse holder to enable the inline fuse holder to continue providing circuit protection.

In some embodiments, the two different types of fuses can be selected from any of the following: mini fuses, automotive fuses, ATO fuses, Class M fuses, and the like. However, embodiments disclosed are not so limited. Instead, the inline fuse holder as disclosed herein can be configured for receiving any type of fuse as would be known and understood by one of ordinary skill in the art.

In some embodiments, the two different types of fuses can have the same amperage or amperages within the same range. However, embodiments disclosed herein are not so limited. Instead, the inline fuse holder as disclosed herein can be configured for fuses with amperages as would be known and understood by one of ordinary skill in the art.

In accordance with disclosed embodiments, the inline fuse holder can include one or more features for preventing both of the two different types of fuses from being connected with the inline fuse holder simultaneously. As such, the two different types of fuses cannot be used with the inline fuse holder at the same time, thereby preventing unsafe operation thereof.

In some embodiments, the inline fuse holder can include a pin that can prevent both of the two different types of fuses from being connected with the inline fuse holder simultaneously. For example, the pin can be disposed in a through hole in a body of the inline fuse holder and slide within the through hole between two different positions. In each of the two different positions, the pin can interfere with a respective one of the two different types of fuses from being connected with the inline fuse holder.

In some embodiments, the pin cannot move by itself. However, when installed in the inline fuse holder, one of the two different types of fuses can push the pin to one of the two different positions to prevent the other of the two different types of fuses from being installed.

In some embodiments, the pin can include shoulders on ends thereof to prevent the pin from falling out of the through hole, for example, by sliding too far into the through hole. In particular, the shoulders can provide stopping mechanisms that can prevent the pin from sliding too far in either direction.

In some embodiments, the fuses themselves can prevent both of the two different types of fuses from being connected with the inline fuse holder simultaneously. For example, when installed in the inline fuse holder, one of the two different types of fuses can physically interfere with the other of the two different types of fuses connecting with the inline fuse holder. In particular, a configuration of terminals in the inline fuse holder can ensure that when one of the two different types of fuses is installed in the inline fuse holder, there is no space for the other of the two different types of fuses to be installed in the inline fuse holder.

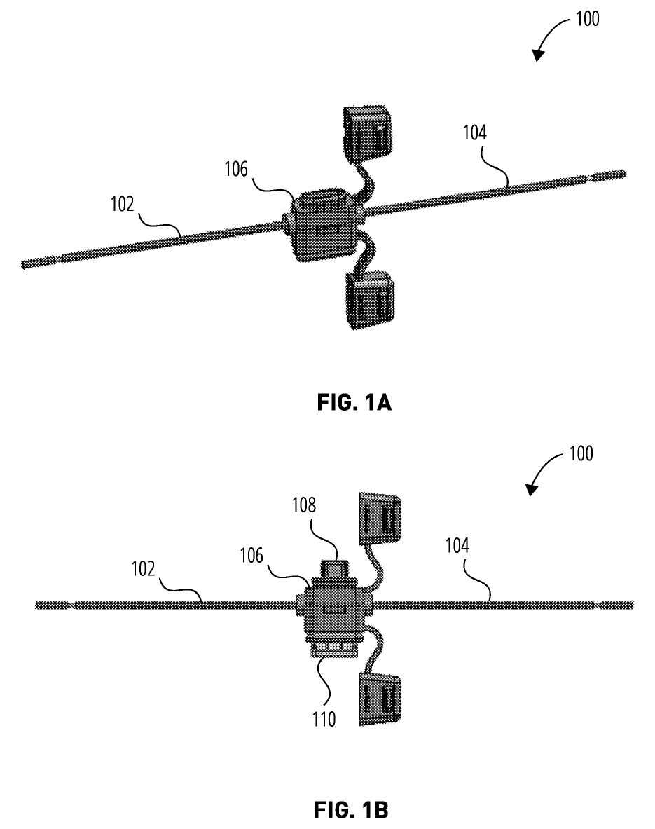

FIG. 1A is a perspective view illustrating an inline fuse holder 100 in accordance with disclosed embodiment, and FIG. 1B is a side view illustrating the inline fuse holder 100 with first and second fuses 108, 110 therein in accordance with disclosed embodiments.

As seen in FIGS. 1A and 1B, the inline fuse holder 100 can include a body 106 and be electrically connected to an input wire 102 and an output wire 104. The body 106 can hold the first fuse 108, which can be electrically connected to the input wire 102 and the output wire 104. Alternatively, the body 106 can hold the second fuse 110, which can be electrically connected to the input wire 102 and the output wire 104. In some embodiments, the body 106 can be over-molded as would be known and understood by one of ordinary skill in the art.

Importantly, although FIGS. 1A and 1B illustrate the body 106 holding both the first fuse 108 and the second fuse 110, it is to be understood that the body 106 cannot hold the first fuse 108 and the second fuse 110 simultaneously. Instead, and as will be described in more detail herein, the inline fuse holder 100 can include one or more features that prevent the body 106 from holding the first fuse 108 and the second fuse 110 at the same time. FIGS. 1A and 1B are only illustrated with both the first fuse 108 and the second fuse 110 to show where the first fuse 108 is located relative to the body 106 when the body 106 holds the first fuse 108 and where the second fuse 110 is located relative to the body 106 when the body 106 holds the second fuse 110.

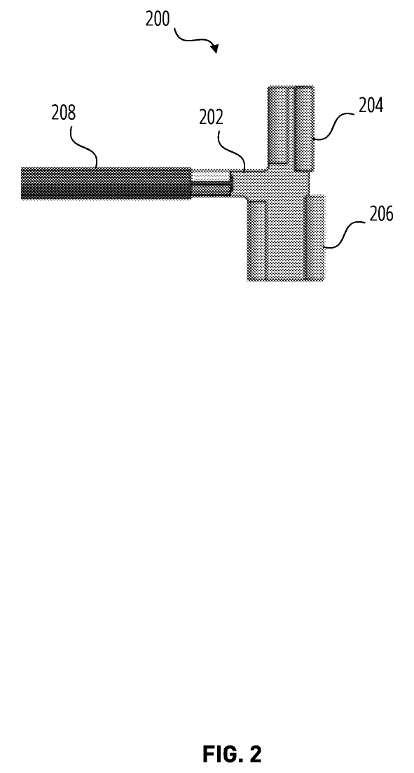

FIG. 2 is a side view illustrating an adapter 200 of an inline fuse holder in accordance with disclosed embodiments. It is to be understood that the adapter 200 can be an input adapter or an output adapter.

The adapter 200 can include a first terminal 202 for electrically connecting with a wire 208. When the adapter 200 is an input adapter, the wire 208 can be an input wire. However, when the adapter 200 is an output adapter, the wire 208 can be an output wire. The adapter 200 can also include a second terminal 204 for electrically connecting with a first fuse, and a third terminal 206 for electrically connecting with a second fuse. The adapter 200 can be formed from copper alloy or any other metal as would be known and understood by one of ordinary skill in the art.

As seen in FIG. 2, the adapter 200 can be formed in a general T-shape. In particular, the second terminal 204 and the third terminal 206 can be co-linear, and the first terminal 202 can be perpendicular to the second terminal 204 and the third terminal 206. However, embodiments disclosed herein are not so limited. Instead, the adapter 200 can be formed in any shape with the terminals 202, 204, 206 oriented relative to one another as would be known and understood by one or ordinary skill in the art.

As also seen in FIG. 2, the second terminal 204 and the third terminal 206 can be different types of terminals. For example, the second terminal 204 can include ends of a flat surface of metal that forms the adapter 200 bent into first and second half circular or C-shapes with a first distance therebetween for holding a fuse relative to the flat surface when inserted in the adapter 200. The third terminal 206 can include ends of the flat surface of the metal that forms the adapter 200 bent into first and second half circular or C-shapes with a second distance therebetween for holding a fuse relative to the flat surface when inserted in the adapter 200. The second distance can be greater than the first distance, thereby configuring the second terminal 204 and the third terminal 206 to hold different types of fuses.

It is to be understood that embodiments disclosed herein are not limited to the types of terminals illustrated in the figures. Instead, the second terminal 204 and the third terminal 206 can include any type of terminal as would be known and understood by one of ordinary skill in the art, including the metal that forms the adapter 200 being shaped, bent, or crimped for connecting with a fuse as disclosed herein. For example, either the second terminal 204 or the third terminal 206 can include a single layer or a double layer of the flat surface that forms the metal of the adapter 200 forming a blade for pressing against a fuse when inserted in the adapter 200. Different applications can necessitate single or double layers for blades of terminals.

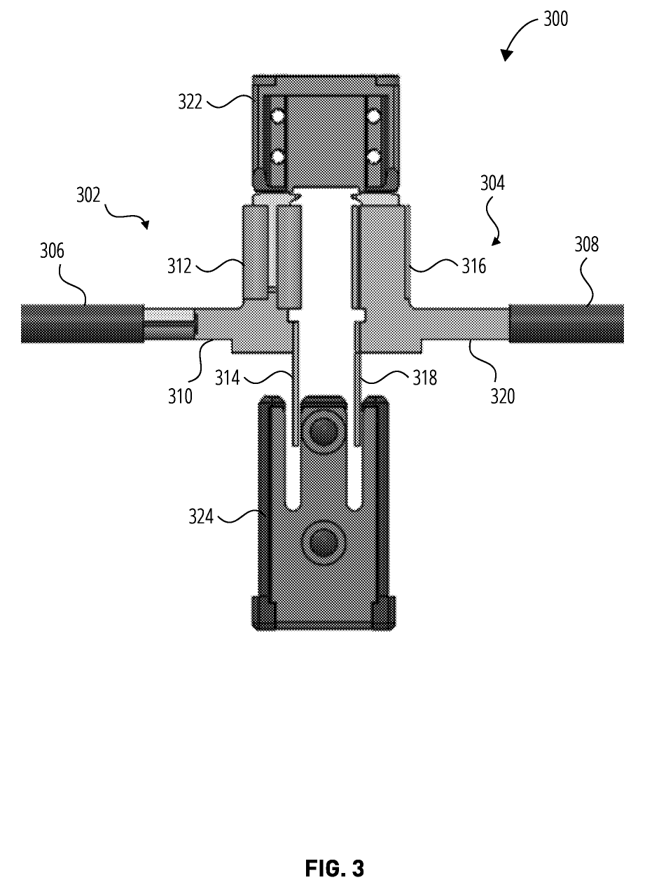

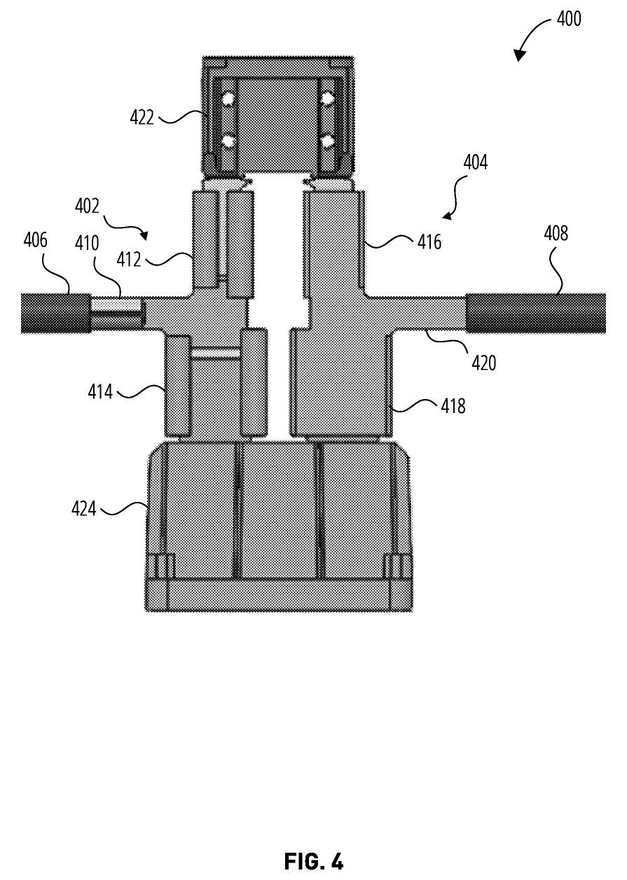

FIG. 3 is a side view illustrating an interior of an inline fuse holder 300 in accordance with disclosed embodiments. It is to be understood that the inline fuse holder 300 can be the same as or similar to the inline fuse holder 100.

As seen in FIG. 3, the inline fuse holder 300 can include an input adapter 302 and an output adapter 304. In this regard, a body, such as the body 106, can house the input adapter 302 and the output adapter 304. The input adapter 302 can be configured for electrically connecting with an input wire 306, a first fuse 322, and a second fuse 324. Similarly, the output adapter 304 can be configured for electrically connecting with the first fuse 322, the second fuse 324, and an output wire 308. The input adapter 302 or the output adapter 304 can be formed from copper alloy or any other metal as would be known and understood by one of ordinary skill in the art.

Importantly, although FIG. 3 illustrates the input adapter 302 and the output adapter 304 being connected to both the first fuse 322 and the second fuse 322, it is to be understood that the input adapter 302 and the output adapter 304 cannot be connected to both the first fuse 322 and the second fuse 324 simultaneously. Instead, and as will be described in more detail herein, the inline fuse holder 300 can include one or more features that prevent the input adapter 302 and the output adapter 304 from being connected to both the first fuse 322 and the second fuse 324 at the same time. FIG. 3 is only illustrated with both the first fuse 322 and the second fuse 324 to show where the first fuse 322 is located relative to the input adapter 302 and the output adapter 304 when the first fuse 322 is connected thereto and where the second fuse 324 is located relative to the input adapter 302 and the output adapter 304 when the second fuse 324 is connected thereto.

In some embodiments, the input adapter 302 can be configured to conduct current carried on the input wire 306 to either the first fuse 322 or the second fuse 324. In particular, the input adapter 302 can include a first input adapter terminal 310 for electrically connecting with the input wire 306, a second input adapter terminal 312 for electrically connecting with the first fuse 322, and a third input adapter terminal 314 for electrically connecting with the second fuse 324. The current carried on the input wire 306 can flow to the first input adapter terminal 310 and then either the second input adapter terminal 312 and the first fuse 322, for example, via metal that forms the input adapter 302, when the first fuse 322 is connected thereto or the third input adapter terminal 314 and the second fuse 324, for example, via the metal that forms the input adapter 302, when the second fuse 324 is connected thereto.

In the embodiment disclosed in FIG. 3, the second input adapter terminal 312 and the third input adapter terminal 314 can be different types of terminals, such as, for example, bent or crimped metal or single or double layers of metal blades. As such, the first fuse 322 and the second fuse 324 can be different types of fuses.

In some embodiments, the output adapter 304 can be configured to conduct current carried through either the first fuse 322 or the second fuse 324 to the output wire 308. In particular, the output adapter 304 can include a first output adapter terminal 316 for electrically connecting with the first fuse 322, a second output adapter terminal 318 for electrically connecting with the second fuse 324, and a third output adapter terminal 320 for electrically connecting with the output wire 308. When the first fuse 322 is connected to the output adapter 304, the current carried through the first fuse 322 can flow to the first output adapter terminal 316 and then the third output adapter terminal 320 and the output wire 308, for example, via metal that forms the output adapter 304. However, when the second fuse 324 is connected to the output adapter 304, the current carried through the second fuse 324 can flow to the second output adapter terminal 318 and then the third output adapter terminal 320 and the output wire 308, for example, via the metal that forms the output adapter 304.

In the embodiments disclosed in FIG. 3, the first output adapter terminal 316 and the second output adapter terminal 318 can be different types of terminals. As such, the first fuse 322 and the second fuse 324 can be different types of fuses.

FIG. 4 is a side view illustrating an interior of an inline fuse holder 400 in accordance with disclosed embodiments. It is to be understood that the inline fuse holder 400 can be the same as or similar to the inline fuse holder 100.

As seen in FIG. 4, the inline fuse holder 400 can include an input adapter 402 and an output adapter 404. In this regard, a body, such as the body 106, can house the input adapter 402 and the output adapter 404. The input adapter 402 can be configured for electrically connecting with an input wire 406, a first fuse 422, and a second fuse 424. Similarly, the output adapter 404 can be configured for electrically connecting with the first fuse 422, the second fuse 424, and an output wire 408. The input adapter 402 or the output adapter 404 can be formed from copper alloy or any other metal as would be known and understood by one of ordinary skill in the art.

Importantly, although FIG. 4 illustrates the input adapter 402 and the output adapter 404 being connected to both the first fuse 422 and the second fuse 422, it is to be understood that the input adapter 402 and the output adapter 404 cannot be connected to both the first fuse 422 and the second fuse 424 simultaneously. Instead, and as will be described in more detail herein, the inline fuse holder 400 can include one or more features that prevent the input adapter 402 and the output adapter 404 from being connected to both the first fuse 422 and the second fuse 424 at the same time. FIG. 4 is only illustrated with both the first fuse 422 and the second fuse 424 to show where the first fuse 422 is located relative to the input adapter 402 and the output adapter 404 when the first fuse 422 is connected thereto and where the second fuse 424 is located relative to the input adapter 402 and the output adapter 404 when the second fuse 424 is connected thereto.

In some embodiments, the input adapter 402 can be configured to conduct current carried on the input wire 406 to either the first fuse 422 or the second fuse 424. In particular, the input adapter 402 can include a first input adapter terminal 410 for electrically connecting with the input wire 406, a second input adapter terminal 412 for electrically connecting with the first fuse 422, and a third input adapter terminal 414 for electrically connecting with the second fuse 424. The current carried on the input wire 406 can flow to the first input adapter terminal 410 and then either the second input adapter terminal 412 and the first fuse 422, for example, via metal that forms the input adapter 402, when the first fuse 422 is connected thereto or the third input adapter terminal 414 and the second fuse 424, for example, via the metal that forms the input adapter 402, when the second fuse 424 is connected thereto.

In the embodiment disclosed in FIG. 4, the second input adapter terminal 412 and the third input adapter terminal 414 can be different types of terminals, such as, for example, bent or crimped metal or single or double layers of metal blades. As such, the first fuse 422 and the second fuse 424 can be different types of fuses.

In some embodiments, the output adapter 404 can be configured to conduct current carried through either the first fuse 422 or the second fuse 424 to the output wire 408. In particular, the output adapter 404 can include a first output adapter terminal 416 for electrically connecting with the first fuse 422, a second output adapter terminal 418 for electrically connecting with the second fuse 424, and a third output adapter terminal 420 for electrically connecting with the output wire 408. When the first fuse 422 is connected to the output adapter 404, the current carried through the first fuse 422 can flow to the first output adapter terminal 416 and then the third output adapter terminal 420 and the output wire 408, for example, via metal that forms the output adapter 404. However, when the second fuse 424 is connected to the output adapter 404, the current carried through the second fuse 424 can flow to the second output adapter terminal 418 and then the third output adapter terminal 420 and the output wire 408, for example, via the metal that forms the output adapter 404.

In the embodiments disclosed in FIG. 4, the first output adapter terminal 416 and the second output adapter terminal 418 can be different types of terminals. As such, the first fuse 422 and the second fuse 424 can be different types of fuses.

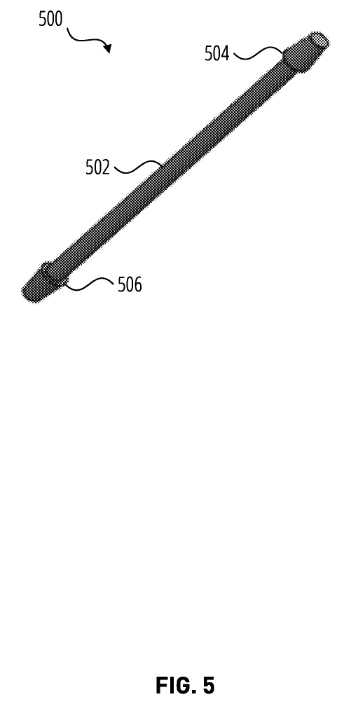

FIG. 5 is a perspective view illustrating a pin 500 in accordance with disclosed embodiments. As seen in FIG. 5, the pin 500 can include an elongated shaft 502 disposed between first and second shoulders 504, 506 on opposing ends of the shaft 502. In some embodiments, the shaft 502 can have a first diameter, the first and second shoulders 504, 506 can have a second diameter, and the second diameter can be greater than the first diameter. In some embodiments, the shaft 502 can be smooth. However, in some embodiments, the pin 500 can include nodules, knurls, or the like on the shaft 502.

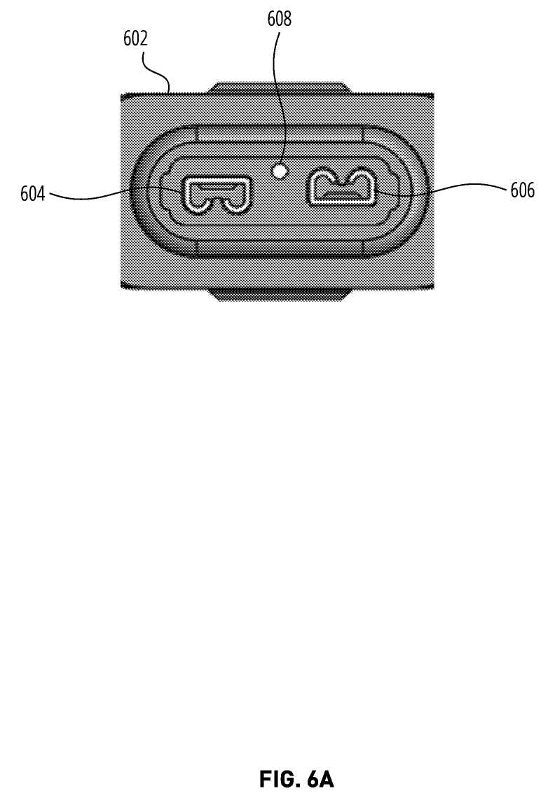

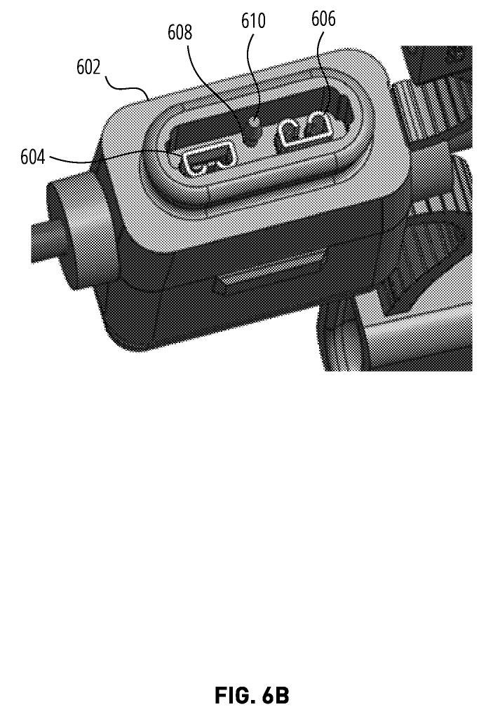

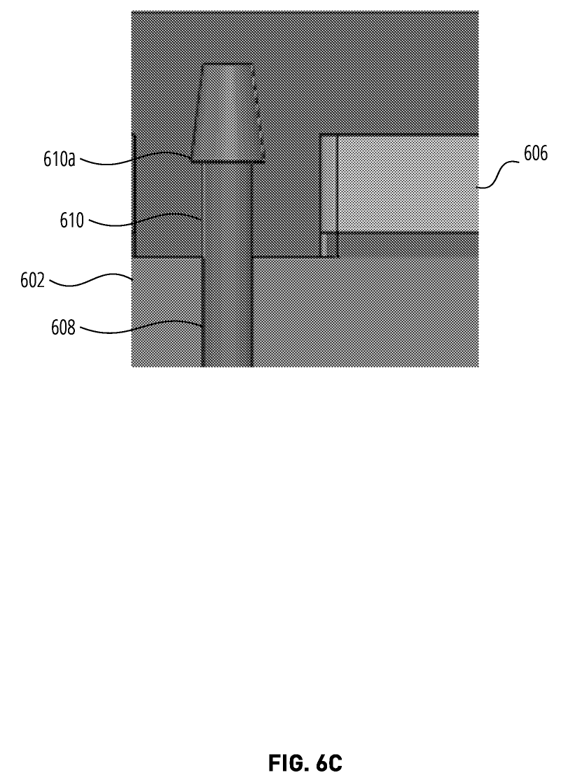

FIG. 6A is a top view illustrating a body 602 of an inline fuse holder with a through hole 608 in accordance with disclosed embodiments. It is to be understood that the body 602 can be the same as or similar to the body 106.

As seen in FIG. 6A, the body 602 can house a first set of terminals 604, 606 that open towards a top side of the body 602. Although not illustrated in FIG. 6A, it is to be understood that the body 602 can also house a second set of terminals. For example, the second set of terminals can be open towards a bottom side of the body 602.

As also seen in FIG. 6A, a through hole 608 can be disposed in the body 602 between the first set of terminals 604, 606. Although not illustrated in FIG. 6A, it is to be understood that the through hole 608 can also be disposed between the second set of terminals. In this regard, the through hole 608 can extend through the body 602 from the top side thereof to the bottom side thereof.

FIG. 6B is a perspective view illustrating the body 602 with a pin 610 disposed in the through hole 608 in accordance with disclosed embodiments, and FIG. 6C is an enlarged side view illustrating the pin 610 disposed in the body 602 in accordance with disclosed embodiments. It is to be understood that the pin 610 can be the same as or similar to the pin 500.

As seen in FIGS. 6B and 6C, the pin 610 can include a first shoulder 610a disposed at a first end of the pin 610 and extending outside of the through hole 608 proximate the first set of terminals 604, 606, for example, on the top side of the body 106. Although not illustrated in FIG. 6C, it is to be understood that the pin 610 can also include a second shoulder disposed at a second end of the pin and extending outside of the through hole 608 proximate the second set of terminals, for example, on the bottom side of the body 602. In some embodiments, the first end of the pin 610, including the first shoulder 610a, can be disposed in between the first set of terminals 604, 606, and the second end of the pin 610, including the second shoulder, can be disposed in between the second set of terminals. It is to be understood that the first shoulder 610a and the second shoulder can be the same as or similar to the shoulders 504, 506.

In some embodiments, the first shoulder 610a and the second shoulder can prevent the pin 610 from falling out of the through hole 608. In particular, in some embodiments, diameters of the first shoulder 610a and the second shoulder can be greater than a diameter of the through hole 608 to prevent the pin 610 from falling out of the through hole 608.

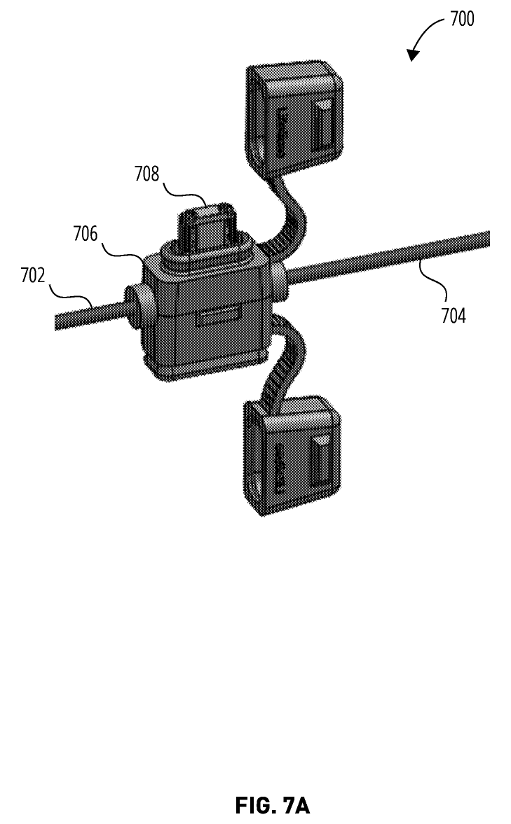

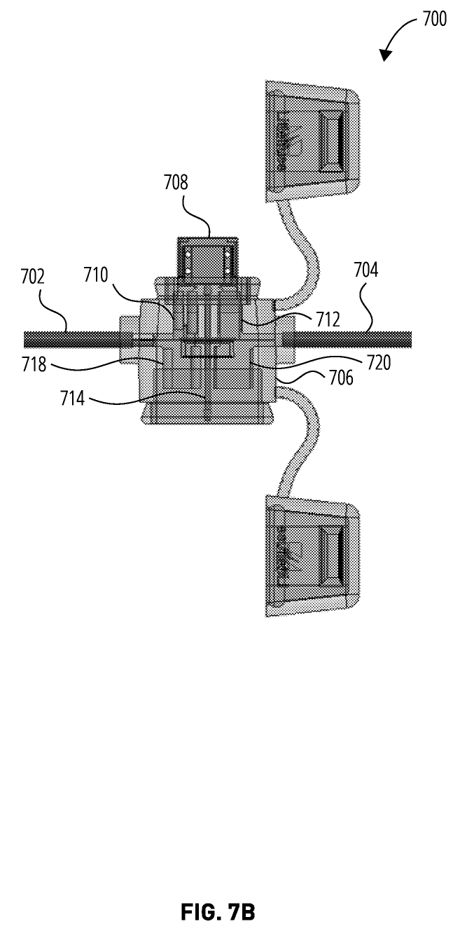

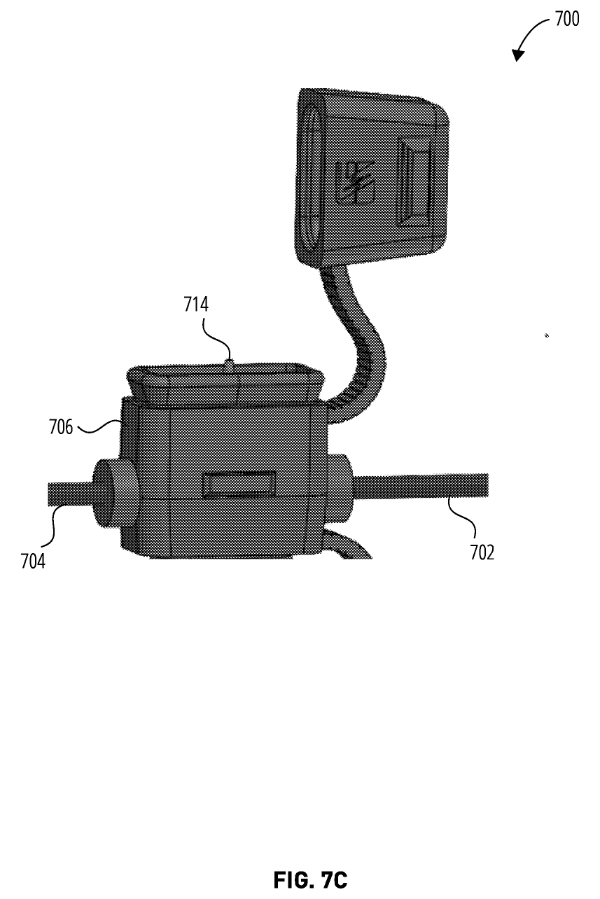

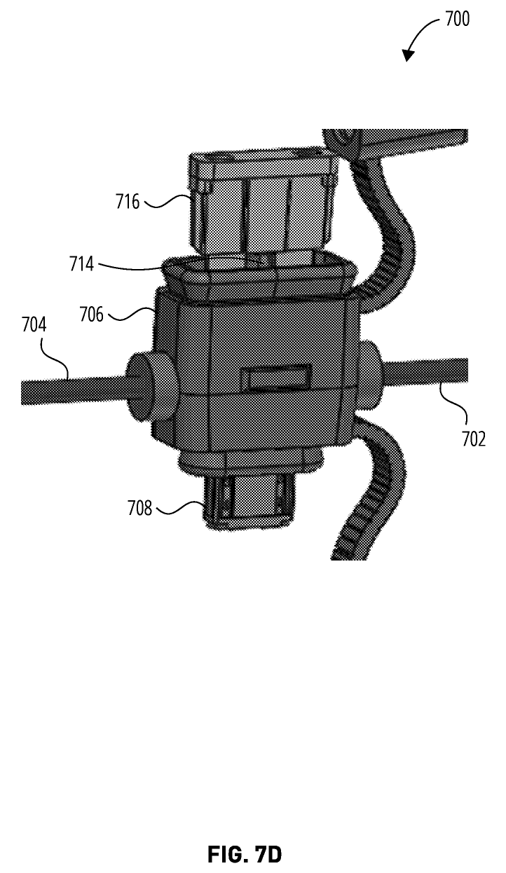

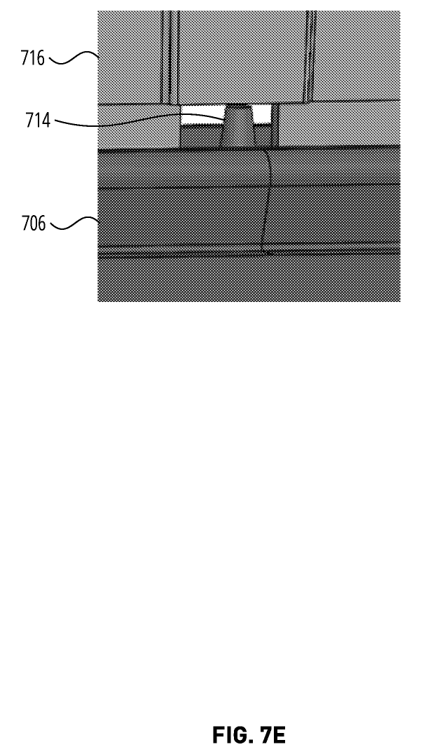

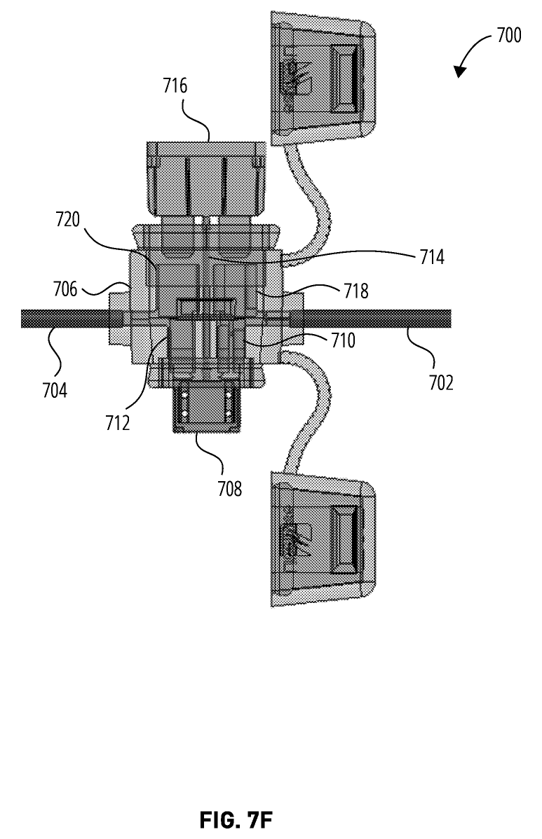

FIGS. 7A-7F are different views illustrating an inline fuse holder 700 electrically connected between an input wire 702 and an output wire 704 in accordance with disclosed embodiments. It is to be understood that the inline fuse holder 700 can be the same as or similar to the inline fuse holder 100, the inline fuse holder 300, or the inline fuse holder 400.

As seen in the figures, the inline fuse holder 700 can include a first set of terminals 710, 712 for electrically connecting with a first fuse 708 and a second set of terminals 718, 720 for electrically connecting with a second fuse 716. In some embodiments, the first set of terminals 710, 712 can be compatible with a first type of fuses that includes the first fuse 708, the second set of terminals 718, 720 can be compatible with a second type of fuses that includes the second fuse 716, and the first type of fuses and the second type of fuses can be different types of fuses.

As also seen in the figures, the inline fuse holder 700 can include a pin 714 disposed in a through hole of a body 706 of the inline fuse holder 700. In some embodiments, the pin 714 can prevent the first fuse 708 from electrically connecting with the first set of terminals 710, 712 when the pin 714 is in a first position and can prevent the second fuse 716 from electrically connecting with the second set of terminals 718, 720 when the pin 714 is in a second position. As seen in FIGS. 7B, 7C, 7D, 7E, and 7F, in particular, when the first fuse 708 is electrically connected with the first set of terminals 710, 712, the first fuse 708 can push the pin 714 into the second position to prevent the second fuse 716 from electrically connecting with the second set of terminals 718, 720. For example, the first fuse 708 can physically engage with a proximate end of the pin 714 to push the pin into the second position.

Although not illustrated in the figures, it is to be understood that in a similar manner, when the second fuse 716 is electrically connected with the second set of terminals 718, 720, the second fuse 716 can push the pin 714 into the first position to prevent the first fuse 708 from electrically connecting with the first set of terminals 710, 712.

Since the pin 714 is disposed in the through hole, the pin 714 can slide within the through hole to move between the first position and the second position. In some embodiments, a diameter of a shaft of the pin 714 can be greater than a diameter of the through hole. However, the body 706 can be made from a material that is soft enough to be flexible, such as TPV or rubber, thereby facilitating the pin 714 pushing through and sliding within the through hole.

As seen in FIGS. 7D, 7E, and 7F, in particular, when the first fuse 708 is electrically connected with the first set of terminals 710, 712 and pushes the pin 714 into the second position, the pin 714 can slide far enough into the through hole so as extend outside of the housing on one side thereof and/or past the second set of terminals 718, 720 in an opening direction thereof so that the pin 714 can prevent and/or physically interfere with the second terminal 718 being connected with the second set of terminals 718, 720. In some embodiments, the second fuse 716 may be partially inserted into the body 706 even when the pin 714 is in the second position. However, when the pin 714 is in the second position, the pin 714 can physically stop the second fuse 716 from being fully inserted into the body 706 and from electrically connecting with the second set of terminals 718, 720.

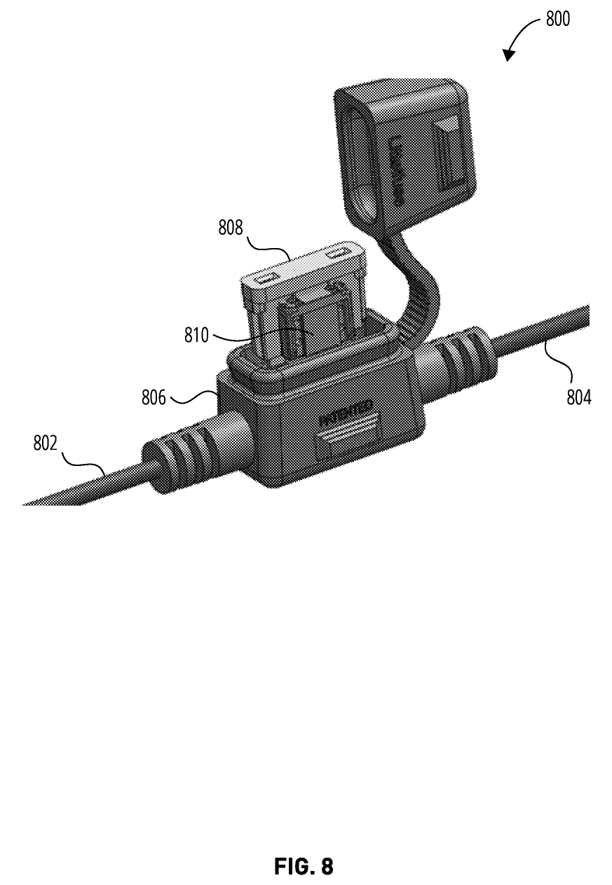

FIG. 8 is a perspective view illustrating an inline fuse holder 800 with fuses 808, 810 therein in accordance with disclosed embodiments. As seen in FIG. 8, the inline fuse holder 800 can include a body 806 and be electrically connected to an input wire 802 and an output wire 804.

The body 806 can hold the first fuse 808, which can be electrically connected to the input wire 802 and the output wire 804. Alternatively, the body 806 can hold the second fuse 810, which can be electrically connected to the input wire 802 and the output wire 804. In some embodiments, the body 806 can be over-molded as would be known and understood by one of ordinary skill in the art.

Importantly, although FIG. 8 illustrates the body 806 holding both the first fuse 808 and the second fuse 810, it is to be understood that the body 106 cannot hold the first fuse 808 and the second fuse 810 simultaneously. Instead, and as will be described in more detail herein, the inline fuse holder 800 can include one or more features that prevent the body 806 from holding the first fuse 808 and the second fuse 810 at the same time. FIG. 8 is only illustrated with both the first fuse 808 and the second fuse 810 to show where the first fuse 808 is located relative to the body 806 when the body 806 holds the first fuse 808 and where the second fuse 810 is located relative to the body 806 when the body 806 holds the second fuse 810.

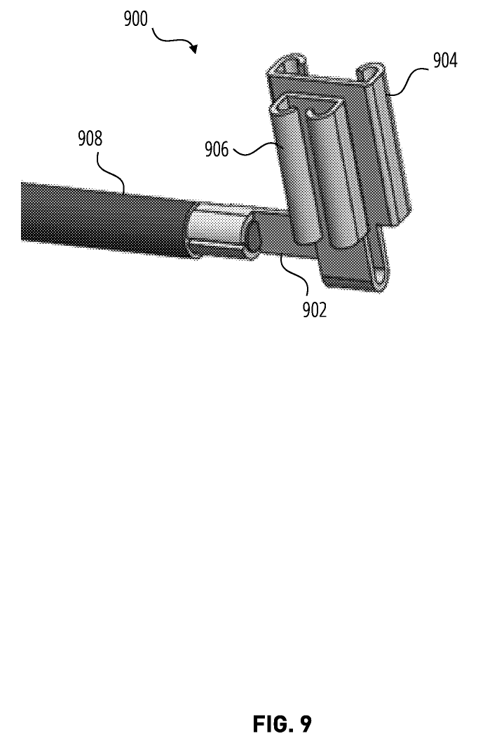

FIG. 9 is a perspective view illustrating an adapter 900 of an inline fuse holder in accordance with disclosed embodiments. It is to be understood that the adapter 900 can be an input adapter or an output adapter.

The adapter 900 can include a first terminal 902 for electrically connecting with a wire 908. When the adapter 900 is an input adapter, the wire 908 can be an input wire. However, when the adapter 900 is an output adapter, the wire 908 can be an output wire. The adapter 900 can also include a second terminal 904 for electrically connecting with a first fuse, and a third terminal 906 for electrically connecting with a second fuse. The adapter 900 can be formed from copper alloy or any other metal as would be known and understood by one of ordinary skill in the art.

As seen in FIG. 9, the adapter 900 can be formed in a general L-shape. In particular, the first terminal 902 can be perpendicular to both the second terminal 904 and the third terminal 906, which can be adjacent to one another and/or side-by-side. However, embodiments disclosed herein are not so limited. Instead, the adapter 900 can be formed in any shape with the terminals 902, 904, 906 oriented relative to one another as would be known and understood by one or ordinary skill in the art.

As also seen in FIG. 9, the second terminal 904 and the third terminal 906 can be different types of terminals. For example, the second terminal 904 can include ends of a flat surface of metal that forms the adapter 900 bent into first and second half circular or C-shapes with a first distance therebetween for holding a fuse relative to the flat surface when inserted in the adapter 900. The third terminal 906 can include ends of the flat surface of the metal that forms the adapter 900 bent into first and second half circular or C-shapes with a second distance therebetween for holding a fuse relative to the flat surface when inserted in the adapter 900. The second distance can be less than the first distance, thereby configuring the second terminal 904 and the third terminal 906 to hold different types of fuses.

It is to be understood that embodiments disclosed herein are not limited to the types of terminals illustrated in the figures. Instead, the second terminal 904 and the third terminal 906 can include any type of terminal as would be known and understood by one of ordinary skill in the art, including the metal that forms the adapter 900 being shaped, bent, or crimped for connecting with a fuse as disclosed herein. For example, either the second terminal 904 or the third terminal 906 can include a single layer or a double layer of the flat surface that forms the metal of the adapter 900 forming a blade for pressing against a fuse when inserted in the adapter 900. Different applications can necessitate single or double layers for blades of terminals.

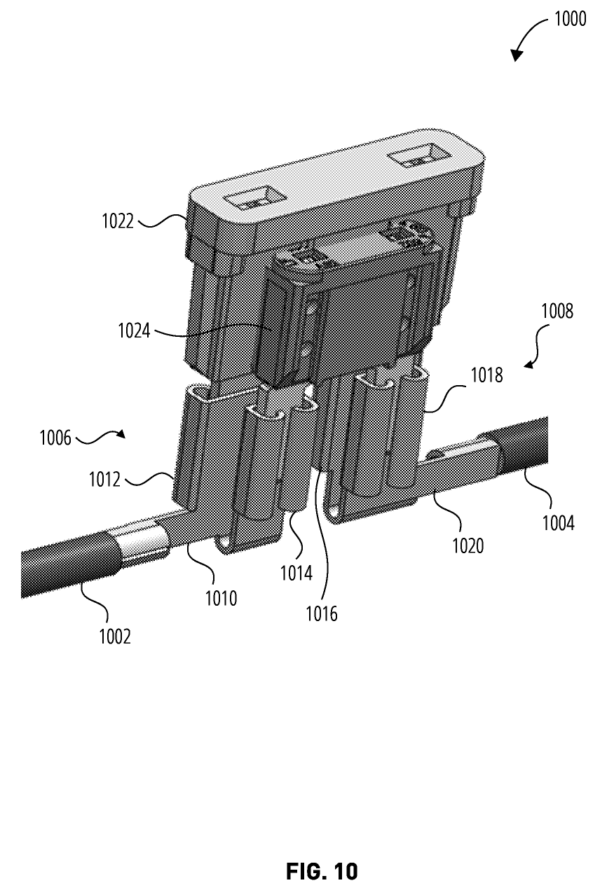

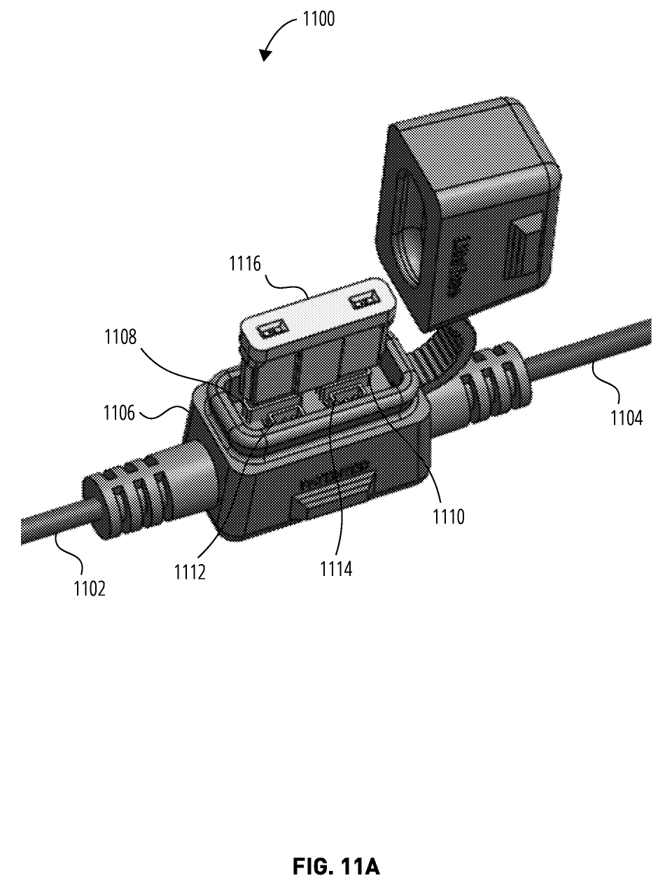

FIG. 10 is a perspective view illustrating an interior of an inline fuse holder 1000 in accordance with disclosed embodiments. It is to be understood that the inline fuse holder 1000 can be the same as or similar to the inline fuse holder 800.

As seen in FIG. 10, the inline fuse holder 1000 can include an input adapter 1006 and an output adapter 1008. In this regard, a body, such as the body 806, can house the input adapter 1006 and the output adapter 1008. The input adapter 1006 can be configured for electrically connecting with an input wire 1002, a first fuse 1022, and a second fuse 1024. Similarly, the output adapter 1008 can be configured for electrically connecting with the first fuse 1022, the second fuse 1024, and an output wire output adapter 1008. The input adapter 1006 or the output adapter 1008 can be formed from copper alloy or any other metal as would be known and understood by one of ordinary skill in the art.

Importantly, although FIG. 10 illustrates the input adapter 1006 and the output adapter 1008 being connected to both the first fuse 1022 and the second fuse 1024, it is to be understood that the input adapter 1006 and the output adapter 1008 cannot be connected to both the first fuse 1022 and the second fuse 1024 simultaneously. Instead, and as will be described in more detail herein, the inline fuse holder 1000 can include one or more features that prevent the input adapter 1006 and the output adapter 1008 from being connected to both the first fuse 1022 and the second fuse 1024 at the same time. FIG. 10 is only illustrated with both the first fuse 1022 and the second fuse 1024 to show where the first fuse 1022 is located relative to the input adapter 1006 and the output adapter 1008 when the first fuse 1022 is connected thereto and where the second fuse 1024 is located relative to the input adapter 1006 and the output adapter 1008 when the second fuse 1024 is connected thereto.

In some embodiments, the input adapter 1006 can be configured to conduct current carried on the input wire 1002 to either the first fuse 1022 or the second fuse 1024. In particular, the input adapter 1006 can include a first input adapter terminal 1010 for electrically connecting with the input wire 1002, a second input adapter terminal 1012 for electrically connecting with the first fuse 1022, and a third input adapter terminal 1014 for electrically connecting with the second fuse 1024. The current carried on the input wire 1002 can flow to the first input adapter terminal 1010 and then either the second input adapter terminal 1012 and the first fuse 1022, for example, via metal that forms the input adapter 1006, when the first fuse 1022 is connected thereto or the third input adapter terminal 1014 and the second fuse 1024, for example, via the metal that forms the input adapter 1006, when the second fuse 1024 is connected thereto.

In the embodiment disclosed in FIG. 10, the second input adapter terminal 1012 and the third input adapter terminal 1014 can be different types of terminals, such as, for example, bent or crimped metal or single or double layers of metal blades. As such, the first fuse 1022 and the second fuse 1024 can be different types of fuses.

In some embodiments, the output adapter 1008 can be configured to conduct current carried through either the first fuse 1022 or the second fuse 1024 to the output wire 1004. In particular, the output adapter 1008 can include a first output adapter terminal 1016 for electrically connecting with the first fuse 1022, a second output adapter terminal 1018 for electrically connecting with the second fuse 1024, and a third output adapter terminal 1020 for electrically connecting with the output wire 1004. When the first fuse 1022 is connected to the output adapter 1008, the current carried through the first fuse 1022 can flow to the first output adapter terminal 1016 and then the third output adapter terminal 1020 and the output wire 1004, for example, via metal that forms the output adapter 1008. However, when the second fuse 1024 is connected to the output adapter 1008, the current carried through the second fuse 1024 can flow to the second output adapter terminal 1018 and then the third output adapter terminal 1020 and the output wire 1004, for example, via the metal that forms the output adapter 1008.

In the embodiments disclosed in FIG. 10, the first output adapter terminal 1016 and the second output adapter terminal 1018 can be different types of terminals. As such, the first fuse 1022 and the second fuse 1024 can be different types of fuses.

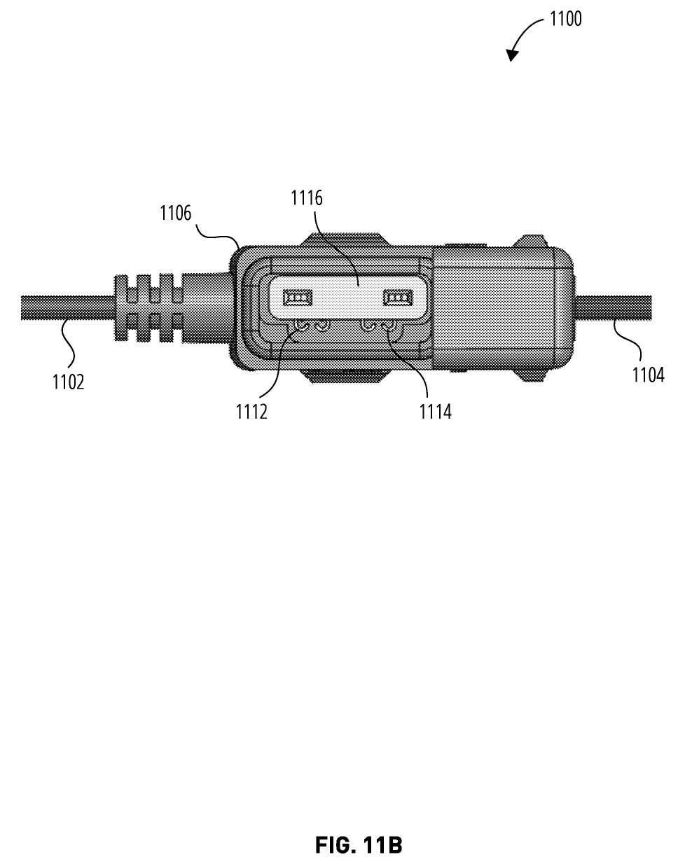

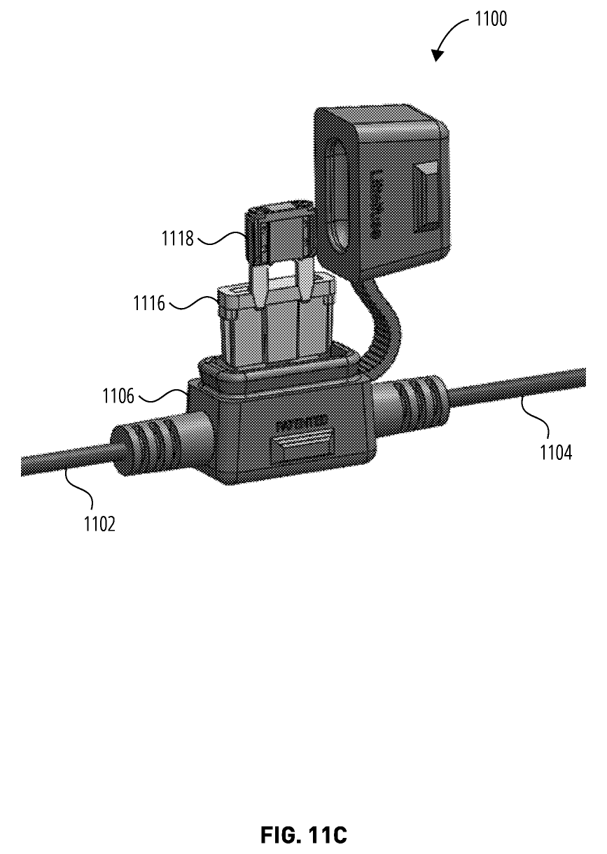

FIGS. 11A-11C are different views illustrating an inline fuse holder 1100 electrically connected between an input wire 1102 and an output wire 1104 in accordance with disclosed embodiments. It is to be understood that the inline fuse holder 1100 can be the same as or similar to the inline fuse holder 800 or the inline fuse holder 1000.

As seen in the figures, the inline fuse holder 1100 can include a first set of terminals 1108, 1110 for electrically connecting with a first fuse 1116 and a second set of terminals 1112, 1114 for electrically connecting with a second fuse 1118. In some embodiments, the first set of terminals 1108, 1110 can be compatible with a first type of fuses that includes the first fuse 1116, the second set of terminals 1112, 1114 can be compatible with a second type of fuses that includes the second fuse 1118, and the first type of fuses and the second type of fuses can be different types of fuses. Both the first set of terminals 1108, 1110 and the second set of terminals 1112, 1114 can be housed in a body 1106.

In the embodiment disclosed in FIGS. 11A-11C, the first set of terminals 1108, 1110 and the second set of terminals 1112, 1114 can be disposed side-by-side for receiving the first fuse 1116 and the second fuse 1118, respectively, in one direction. However, embodiments disclosed herein are not so limited. Instead, the first set of terminals 1108, 1110 and the second set of terminals 1112, 1114 can be oriented relative to one another in any manner as would be known and understood by one of ordinary skill in the art. For example, in some embodiments, the first set of terminals 1108, 1110 can open towards a first direction for receiving the first fuse 1116, the second set of terminals 1112, 1114 can open towards a second direction for receiving the second fuse 1118, and the first direction and the second direction can be opposite one another.

In any embodiment, when the first fuse 1116 is electrically connected with the first set of terminals 1108, 1110, the first fuse 1116 can prevent the second fuse 1118 from electrically connecting with the second set of terminals 1112, 1114. Similarly, when the second fuse 1118 is electrically connected with the second set of terminals 1112, 1114, the second fuse 1118 can prevent the first fuse 1116 from electrically connecting with the first set of terminals 1108, 1110.

As seen in FIGS. 11B and 11C, in particular, when the first fuse 1116 is electrically connected with the first set of terminals 1108, 1110, the first fuse 1116 can physically interfere with the second fuse 1118 electrically connecting with the second set of terminals 1112, 1114. For example, when the first fuse 1116 is electrically connected with the first set of terminals 1108, 1110, the first fuse 1116 can partially or fully block physical access to the second set of terminals 1112, 1114. Although not illustrated in the figures, it is to be understood that in a similar manner, when the second fuse 1118 is electrically connected with the second set of terminals 1112, 1114, the second fuse 1118 can physically interfere with the first fuse 1116 electrically connecting with the first set of terminals 1108, 1110.

In some embodiments, the second fuse 1118 may be partially inserted into the body 1106 even when the first fuse 1116 is connected with the first set of terminals 1108, 1110. However, when the first fuse 1116 is connected with the first set of terminals 1108, 1110, the first fuse 1116 can physically stop the second fuse 1118 from being fully inserted into the body 1106 and from electrically connecting with the second set of terminals 1112, 1114.

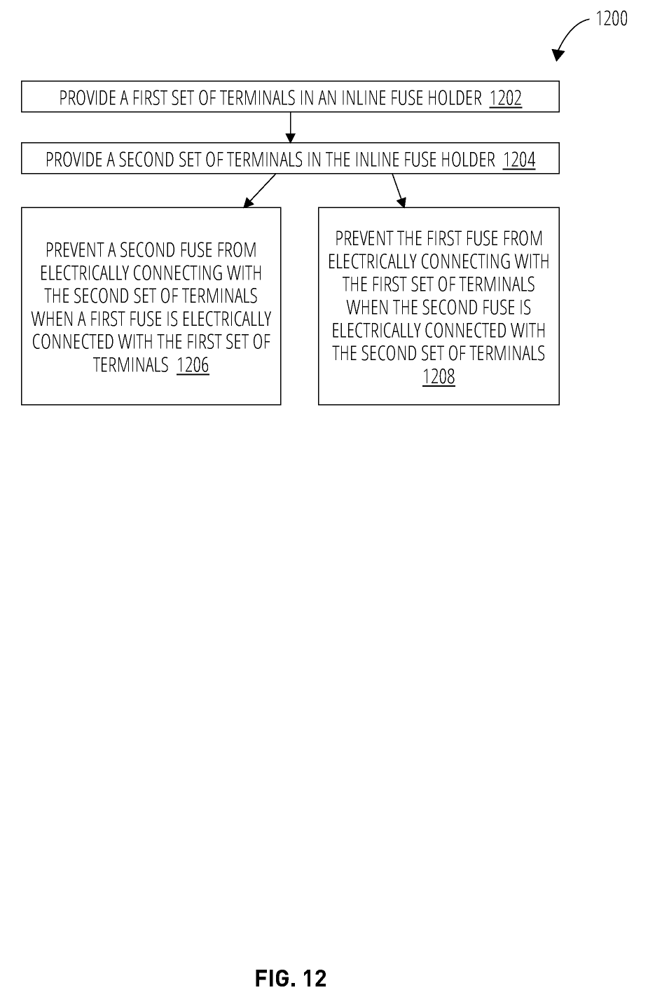

FIG. 12 is a flow chart illustrating a method 1200 in accordance with disclosed embodiments. In some embodiments, the inline fuse holder 100, the inline fuse holder 300, the inline fuse holder 400, the inline fuse holder 700, the inline fuse holder 800, the inline fuse holder 1000, and/or the inline fuse holder 1100 can execute some or all of the method 1200.

As seen in FIG. 12, the method 1200 can include providing a first set of terminals in an inline fuse holder as in 1202 and providing a second set of terminals in the inline fuse holder as in 1204. In some embodiments, the method 1200 can also include electrically connecting an input wire to an input terminal of the first set of terminals and and an input terminal of the second set of terminals and electrically connecting an output wire to an output terminal of the first set of terminals and an output terminal of the second set of terminals.

As also seen in FIG. 12, the method 1200 can include preventing a second fuse from electrically connecting with the second set of terminals when a first fuse is electrically connected with the first set of terminals as in 1206. Similarly, the method 1200 can include preventing the first fuse from electrically connecting with the first set of terminals when the second fuse is electrically connected with the second set of terminals as in 1208.

In some embodiments, the method 1200 can implement physical interference to prevent the first fuse or the second fuse from being electrically connected with the inline fuse holder. For example, in some embodiments, the method 1200 can include the first fuse physically interfering with the second fuse electrically connecting with the second set of terminals when the first fuse is electrically connected with the first set of terminals. Similarly, in some embodiments, the method 1200 can include the second fuse physically interfering with the first fuse electrically connecting with the first set of terminals when the second fuse is electrically connected with the second set of terminals.

Additionally or alternatively, in some embodiments, the method 1200 can incorporate a pin to prevent the first fuse or the second fuse from being electrically connected with the inline fuse holder. For example, in some embodiments, the method 1200 can include providing a pin between the first set of terminals and the second set of terminals. In these embodiments, the method 1200 can include the second fuse pushing the pin into a first position when the second fuse is electrically connected with the second set of terminals and the pin preventing the first fuse from electrically connecting with the first set of terminals when the pin is in the first position. Similarly, in these embodiments, the method 1200 can include the first fuse pushing the pin into a second position when the first fuse is electrically connected with the first set of terminals and the pin preventing the second fuse from electrically connecting with the second set of terminals when the pin is in the second position.

For example, the method 1200 can include disposing the pin in a through hole of a body housing the first set of terminals and the second set of terminals and sliding the pin within the through hole to move between the first position and the second position. In some embodiments, the method 1200 can also include preventing the pin from falling out of the through hole with shoulders on ends of the pin that extend outside of the through hole on opposing sides thereof. In some embodiments, the shoulders can have diameters larger than a diameter of the through hole.

As used herein, an element or a step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

While the present disclosure makes reference to certain embodiments, numerous modifications, alterations, and changes to the described embodiments are possible without departing from the sphere and scope of the present disclosure, as defined in the appended claims. Accordingly, it is intended that the present disclosure not be limited to the described embodiments, but that it has the full scope defined by the language of the following claims and equivalents thereof.

What is claimed is:

1. An inline fuse holder comprising:
a first set of terminals for electrically connecting with a first fuse;
a second set of terminals for electrically connecting with a second fuse; and
a pin for preventing the first fuse from electrically connecting with the first set of terminals when the pin is in a first position and for preventing the second fuse from electrically connecting with the second set of terminals when the pin is in a second position.

2. The inline fuse holder of claim 1 wherein the first fuse pushes the pin into the second position when the first fuse is electrically connected with the first set of terminals, and wherein the second fuse pushes the pin into the first position when the second fuse is electrically connected with the second set of terminals.

3. The inline fuse holder of claim 1 further comprising:
a body housing the first set of terminals and the second set of terminals.

4. The inline fuse holder of claim 3 further comprising:
a through hole disposed in the body between the first set of terminals and the second set of terminals,
wherein the pin is disposed in the through hole and slides within the through hole to move between the first position and the second position.

5. The inline fuse holder of claim 4 further comprising:
a first shoulder disposed at a first end of the pin and extending outside of the through hole proximate the first set of terminals; and
a second shoulder disposed at a second end of the pin and extending outside of the through hole proximate the second set of terminals,
wherein the first shoulder and the second shoulder prevent the pin from falling out of the through hole.

6. The inline fuse holder of claim 5 wherein diameters of the first shoulder and the second shoulder are greater than a diameter of the through hole.

7. The inline fuse holder of claim 6 wherein a diameter of a shaft of the pin disposed between the first shoulder and the second shoulder is greater than a diameter of the through hole.

8. The inline fuse holder of claim 6 wherein the first set of terminals is compatible with a first type of fuses, wherein the second set of terminals is compatible with a second type of fuses, and wherein the first type of fuses and the second type of fuses are different types of fuses.

9. An inline fuse holder comprising:
a first set of terminals for electrically connecting with a first fuse; and
a second set of terminals for electrically connecting with a second fuse,
wherein the first fuse prevents the second fuse from electrically connecting with the second set of terminals when the first fuse is electrically connected with the first set of terminals, and
wherein the second fuse prevents the first fuse from electrically connecting with the first set of terminals when the second fuse is electrically connected with the second set of terminals.

10. The inline fuse holder of claim 9 wherein the first fuse physically interferes with the second fuse electrically connecting with the second set of terminals when the first fuse is electrically connected with the first set of terminals, and wherein the second fuse physically interferes with the first fuse electrically connecting with the first set of terminals when the second fuse is electrically connected with the second set of terminals.

11. The inline fuse holder of claim 9 further comprising:
a body housing the first set of terminals and the second set of terminals.

12. The inline fuse holder of claim 9 wherein the first set of terminals is compatible with a first type of fuse, and wherein the second set of terminals is compatible with a second type of fuse, and wherein the first type of fuse and the second type of fuse are different types of fuses.

13. The inline fuse holder of claim 9 wherein the first set of terminals and the second set of terminals are disposed side-by-side for receiving the first fuse and the second fuse, respectively, in one direction.

14. The inline fuse holder of claim 9 wherein the first set of terminals opens towards a first direction for receiving the first fuse, wherein the second set of terminals opens towards a second direction for receiving the second fuse, and wherein the first direction and the second direction are opposite one another.

15. A method comprising:
providing a first set of terminals in an inline fuse holder;
providing a second set of terminals in the inline fuse holder;
preventing a second fuse from electrically connecting with the second set of terminals when a first fuse is electrically connected with the first set of terminals; and
preventing the first fuse from electrically connecting with the first set of terminals when the second fuse is electrically connected with the second set of terminals.

16. The method of claim 15 further comprising:
providing a pin between the first set of terminals and the second set of terminals;
pushing, by the second fuse, the pin into a first position when the second fuse is electrically connected with the second set of terminals, the pin preventing the first fuse from electrically connecting with the first set of terminals when the pin is in the first position; and
pushing, by the first fuse, the pin into a second position when the first fuse is electrically connected with the first set of terminals, the pin preventing the second fuse from electrically connecting with the second set of terminals when the pin is in the second position.

17. The method of claim 16 further comprising:
disposing the pin in a through hole of a body housing the first set of terminals and the second set of terminals; and
sliding the pin within the through hole to move between the first position and the second position.

18. The method of claim 17 further comprising:
preventing the pin from falling out of the through hole with shoulders on ends of the pin that extend outside of the through hole on opposing sides thereof, the shoulders having diameters larger than a diameter of the through hole.

19. The method of claim 15 further comprising:
physically interfering, by the first fuse, with the second fuse electrically connecting with the second set of terminals when the first fuse is electrically connected with the first set of terminals; and
physically interfering, by the second fuse, with the first fuse electrically connecting with the first set of terminals when the second fuse is electrically connected with the second set of terminals.

20. The method of claim 15 further comprising:
electrically connecting an input wire to an input terminal of the first set of terminals and and an input terminal of the second set of terminals; and
electrically connecting an output wire to an output terminal of the first set of terminals and an output terminal of the second set of terminals.
